(19) United States
(12) Patent Application Publication
(10) Pub. No.: US 2014/0164975 A1
(43) Pub. Date: Jun. 12, 2014

(54) TERMINAL WITH MOVING KEYBOARD AND METHOD FOR DISPLAYING MOVING KEYBOARD THEREOF

(71) Applicant: Dong Sung Kang, Incheon (KR)

(72) Inventor: Dong Sung Kang, Incheon (KR)

(21) Appl. No.: 13/918,267

(22) Filed: Jun. 14, 2013

(30) Foreign Application Priority Data
Dec. 6, 2012 (KR) 10-2012-0141132

(51) Int. Cl. G06F 3/0488; G06F 3/0481; G06F 3/0484

(52) U.S. Cl. CPC G06F 3/04886; G06F 3/04845; G06F 3/04817
USPC 715/773

(57) ABSTRACT

A terminal with a moving keyboard that includes a computer processor and a memory is provided. The terminal includes a display; and a moving keyboard application configured to be loaded into the memory under the control of the computer processor, to generate a moving keyboard which is displayed while moving at a predetermined speed in a pre-set method, and to display the moving keyboard on the display.

### CROSS-REFERENCE TO RELATED PATENT APPLICATION

This application claims priority from Korean Patent Application No. 10-2012-0141132, filed on Dec. 6, 2012 in the Korean Intellectual Property Office, the disclosure of which is incorporated herein by reference in its entirety.

### FIELD

Apparatuses and methods consistent with the exemplary embodiments relate to a terminal with a moving keyboard and a method for displaying a moving keyboard thereof, and more particularly, to a terminal with a moving keyboard, which have characters of the keyboard move as if they flow, and a method for displaying a moving keyboard thereof.

### BACKGROUND

In recent years, terminals with a touch screen function have been widely distributed. This is because portability and simplicity of terminals have been emphasized and accordingly input methods using touch screen technology have become popularized

Since most of the keyboards applied to existing terminals have letters, numerals, and symbols fixedly arranged and displayed, users only input letters, numerals, and symbols in their fixed positions. However, such a related-art input method has the following problems:

In the case of portable apparatuses portability of which has been emphasized, the trend toward miniaturization continues. Therefore, letters, numerals, and symbols are displayed on a small screen as many as possible and thus a space to display the keyboard is small. Accordingly, a touch space for a user to touch a character as he/she wants is not sufficient and the probability that the user makes typographical errors increases. To this end, an extra time to correct the typographical errors is required. In order to avoid such inconvenience, the user may connect a removable keyboard with the portable apparatus. However, since the removable keyboard should be additionally purchased and provided, the portability of the portable apparatus is reduced.

### SUMMARY

One or more aspects of the exemplary embodiments provide a terminal with a moving keyboard, which can solve a problem that arises when a user inputs data because a keyboard is small due to a fixed screen size of a terminal, and can minimize the frequency of typographical errors, and allows the user to use the keyboard effectively, and a method for displaying a moving keyboard thereof.

According to an aspect of an exemplary embodiment, there is provided a terminal with a moving keyboard that includes a computer processor and a memory, the terminal including: a display; and a moving keyboard application configured to be loaded into the memory under the control of the computer processor, to generate a moving keyboard which is displayed while moving at a predetermined speed in a pre-set method, and to display the moving keyboard on the display.

According to an aspect of another exemplary embodiment, there is provided a method for displaying a moving keyboard of a terminal which includes a computer processor, a memory, and a display, the method including: by a moving keyboard application which is loaded into the memory under the control of the computer processor and operated, generating a moving keyboard which is displayed while moving in a pre-set method; and displaying the moving keyboard generated by the moving keyboard application on the display.

According to an aspect of another exemplary embodiment, there is provided a computer-readable recording medium which stores a moving keyboard application according to exemplary embodiments.

According to exemplary embodiments, the keyboard may be displayed as if they flow like subtitles, considering a fixed screen size of the terminal.

Also, according to exemplary embodiments, the moving keyboard is generated and displayed, so that the frequency of typographical errors occurring due to a small display space of the keyboard can be minimized, and the user can easily find a character that he/she wants.

Also, according to exemplary embodiments, the user can directly set various environments of the moving keyboard considering his/her taste, so that user's convenience can be improved.

Additional aspects and advantages of the exemplary embodiments will be set forth in the detailed description, will be obvious from the detailed description, or may be learned by practicing the exemplary embodiments.

### BRIEF DESCRIPTION OF THE DRAWINGS

The above and other features and advantages will become more apparent by describing in detail exemplary embodiments with reference to the attached drawings in which:

FIG. 1 is a view schematically illustrating a terminal with a moving keyboard according to an exemplary embodiment;

FIG. 2 is a view illustrating an example of a moving keyboard menu setting screen according to an exemplary embodiment;

FIG. 3 is a view illustrating an example of a screen to select a type of keyboard according an exemplary embodiment;

FIGS. 4A and 4B are views to explain an example of a moving keyboard showing numerals and symbols according to an exemplary embodiment;

FIG. 5A is a view illustrating an example of a moving Hangul (Korean alphabet) keyboard in which keys are arranged in a multi-row method;

FIG. 5B is a view illustrating an example of a moving Hangul keyboard in which a key font size is changed according to an exemplary embodiment;

FIG. 5C is a view illustrating an example of a moving Hangul keyboard in which a font size varies according to a type of keyboard according to an exemplary embodiment;

FIG. 5D is a view illustrating an example of a moving Hangul keyboard which highlights one of the Hangul letters that are displayed on a keyboard display according to an exemplary embodiment;

FIG. 6A is a view illustrating an example of a moving alphabet keyboard in which keys are arranged in a multi-row method according to an exemplary embodiment;

FIG. 6B is a view illustrating an example of a moving alphabet keyboard in which arrangements of keys are changed according to an exemplary embodiment;

FIG. 6C is a view illustrating an example of a moving alphabet keyboard in which a gap between the different rows of keys is changed according to an exemplary embodiment;

FIG. 7 is a view illustrating an example of a moving keyboard which is displayed on a portrait view screen of a terminal in a vertical direction according to an exemplary embodiment;

FIG. 8 is a view illustrating an example of a moving keyboard which is displayed on a landscape view screen of a terminal in a vertical direction according to an exemplary embodiment;

FIG. 9 is a view illustrating an example of a moving keyboard which is displayed on a landscape view screen of a terminal in a horizontal direction and a vertical direction according to an exemplary embodiment;

FIG. 10 is a block diagram illustrating a terminal which provides a moving keyboard according to an exemplary embodiment; and

FIG. 11 is a flowchart illustrating a method for displaying a moving keyboard of a terminal according to an exemplary embodiment.

### DETAILED DESCRIPTION

Exemplary embodiments will now be described more fully with reference to the accompanying drawings to clarify aspects, features and advantages of the inventive concept. The exemplary embodiments may, however, be embodied in many different forms and should not be construed as limited to the exemplary embodiments set forth herein. Rather, the exemplary embodiments are provided so that this disclosure will be thorough and complete, and will fully convey the scope of the application to those of ordinary skill in the art.

It will be understood that when an element is referred to as being “on” another element, the element can be directly on another element or intervening elements. In the drawings, thicknesses of elements are exaggerated for easy understanding of technical features.

If the terms such as ‘first’ and ‘second’ are used to describe elements, these element should not be limited by such terms. These terms are used for the purpose of distinguishing one element from another element only. The exemplary embodiments include their complementary embodiments.

Also, it will be understood that when a first element (or first component) is referred to as being operated or executed “on” a second element (or second component), the first element (or first component) can be operated or executed in an environment where the second element (second component) is operated or executed or can be operated or executed by interacting with the second element (second component) directly or indirectly.

Also, it will be understood that when an element, component, apparatus or system is referred to as comprising a component consisting of a program or software, the element, component, apparatus or system can comprise hardware (for example, a memory or a central processing unit (CPU)) necessary for executing or operating the program or software or another program or software (for example, a operating system (OS), a driver necessary for driving a hardware), unless the context clearly indicates otherwise.

Also, it will be understood that an element (or component) can be realized by software, hardware, or software and hardware, unless the context clearly indicates otherwise.

The terms used herein are for the purpose of describing particular exemplary embodiments only and are not intended to be limiting. As used herein, the singular forms “a”, “an” and “the” are intended to include the plural forms as well, unless the context clearly indicates otherwise. It will be further understood that the terms “comprises” and/or “comprising,” when used in this specification, do not preclude the presence or addition of one or more other components.

Hereinafter, exemplary embodiments will be described in greater detail with reference to the accompanying drawings. The matters defined in the description, such as detailed construction and elements, are provided to assist in a comprehensive understanding of the exemplary embodiments. However, it is apparent that the exemplary embodiments can be carried out by those of ordinary skill in the art without those specifically defined matters. In the description of the exemplary embodiment, certain detailed explanations of related art are omitted when it is deemed that they may unnecessarily obscure the essence of the inventive concept.

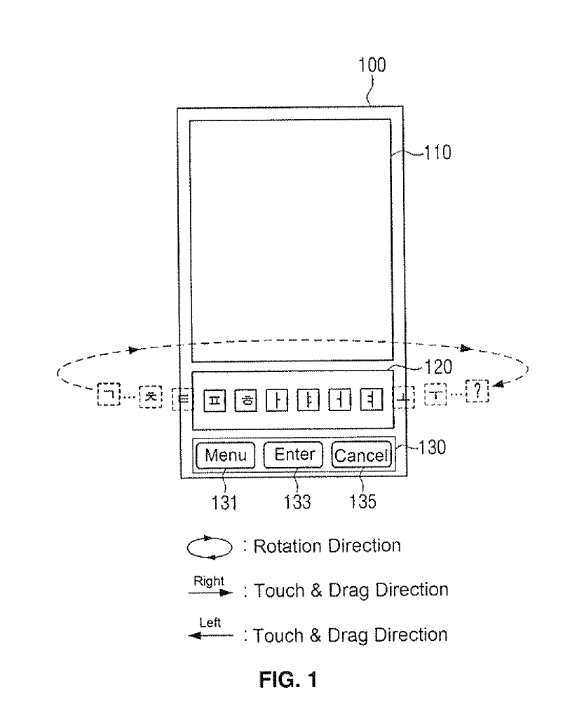

FIG. 1 is a view schematically illustrating a terminal with a moving keyboard according to an exemplary embodiment.

Referring to FIG. 1, a terminal with a moving keyboard may display a moving keyboard according to an exemplary embodiment on a display 100.

The moving keyboard according to the exemplary embodiment continues to move in a predetermined direction at a predetermined speed. The predetermined speed or the predetermined direction recited herein may be set by a user or set as default.

The moving keyboard according to an exemplary embodiment may be a transparent keyboard. That is, the moving keyboard may be configured to be transparent so that a background behind the moving keyboard can be seen as it is.

A user of the moving keyboard according to the present exemplary embodiment may input a character that he/she wants by placing his/her finger in the proximity of a location where the moving keyboard moves, and touching when the letter, numeral or symbol (hereinafter, referred to as a character) that he/she wants passes.

The terminal with the moving keyboard according to an exemplary embodiment may display a character which is input through the display 100 on a data display 110, and may display the moving keyboard on a keyboard display 120. On the other hand, the terminal with the moving keyboard according to an exemplary embodiment may additionally display a setting part 130 which sets an environment of the moving keyboard.

If the terminal or the display 100 supports a touch method, the data display 110, the keyboard display 120, and the setting part 130 may be displayed on a touch panel. In the exemplary embodiments, a method for selecting and inputting a character in a touch method will be explained. However, this is merely an example and is not limited to the touch method.

The data display 110 is a region on which data that the user inputs through the moving keyboard displayed on the keyboard display 120, that is, letters, numerals, or symbols, are displayed. The user may select a letter, numeral or symbol that he/she wants from among keys displayed on the keyboard display 120 by touching it, and the selected letter, numeral, or symbol is displayed on the data display 110.

The keyboard display 120 is a region that displays a keyboard supported by the terminal or a moving keyboard application installed in the terminal. The moving keyboard application may be a program code which is operated in a computer.

Although not shown, the terminal may further include a computer processor and memory in addition to the display 100, and the moving keyboard application may be loaded into the memory under the control of the computer processor, may generate the moving keyboard, and then may display the moving keyboard on the display 100.

FIG. 1 illustrates an example of a moving keyboard which is displayed on the keyboard display 120 and in which Hangul consonants, Hangul vowels, and symbols are arranged in a row.

The Hangul consonants, Hangul vowels, symbols may be displayed on the keyboard display 120 as if they rotate in a direction shown in the drawing. The rotation direction is changeable. Also, letters in dashed line boxes of FIG. 1 are not displayed on the keyboard display 120, but are illustrated to explain that they are displayed on the keyboard display 120 in sequence as a time elapses. For example, ‘ [symbol] , [symbol] , [symbol] , [symbol] , [symbol] , [symbol] ’ in solid line boxes are currently displayed on the keyboard display 120. When the Hangul consonants and vowels are set to move to the right, ‘ [symbol] , [symbol] , [symbol] , [symbol] , [symbol] , [symbol] ’ move to the right at a constant speed. Accordingly, after a predetermined time elapses, ‘ [symbol] ’, which has been in the dashed line box, and ‘ [symbol] , [symbol] , [symbol] , [symbol] , [symbol] ’ are displayed on the keyboard display 120. When a further time elapses, ‘ [symbol] ’ which has been in the dashed line box′ and ‘ [symbol] , [symbol] , [symbol] , [symbol] , [symbol] ’ are displayed on the keyboard display 120.

In order to change the moving direction of the keyboard from the right to the left, the user may touch the keyboard display 120 and then may drag it to the left. When the user touches the keyboard display 120 and drags it the left, the moving keyboard application may display a keyboard that moves to the left at a constant speed on the keyboard display 120.

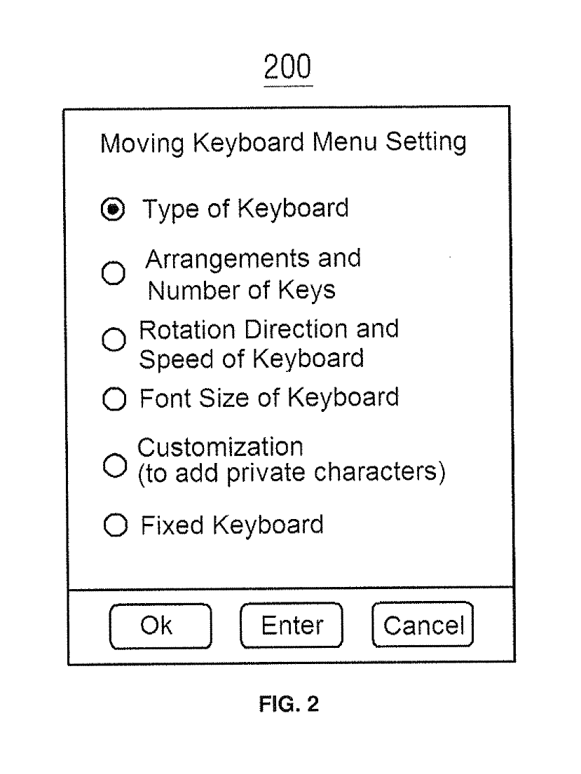

The setting part 130 is a region on which a predetermined setting screen is displayed. In the present exemplary embodiment, the setting menu includes a menu button 131 to set an environment of the moving keyboard (moving keyboard menu setting screen), an enter button 133 to input data, and a cancel button 135 to cancel input of data. When the user presses the menu button 131, the moving keyboard application may generate a moving keyboard menu setting screen 200 as shown in FIG. 2 and may display the moving keyboard menu setting screen 200 on the display 100.

The setting screen may be displayed when the moving keyboard is displayed, or may be hidden. When the setting screen does not appear on the display 110 and is hidden, the setting screen may be displayed on the display 100 by touching a certain region of the display 100.

The moving keyboard displayed on the keyboard display 120 may be a transparent keyboard. In this case, a background behind the keyboard display 120 can be seen as it is.

The generating and displaying the setting screen may be implemented by the above-described moving keyboard application.

FIG. 2 is a view illustrating an example of the moving keyboard menu setting screen 200 according to an exemplary embodiment.

Referring to FIGS. 1 and 2, when the user selects the menu button 131, the moving keyboard application displays the moving keyboard menu setting screen 200. The moving keyboard application may display the moving keyboard menu setting screen 200 by overwriting the data display 110 with it, or may display the moving keyboard menu setting screen 200 in a pop-up window form. Alternatively, the moving keyboard application may display the moving keyboard menu setting screen 200 transparently. The moving keyboard menu setting screen 200 may include menus to convert a type of keyboard, arrangements and number of keys, a rotation direction and a rotation speed of the keyboard, a font size of the keyboard, customization, and a fixed keyboard.

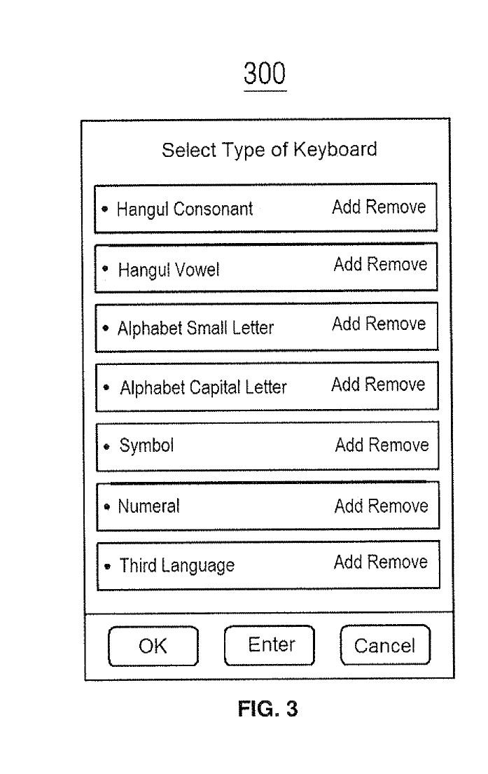

When the user selects the type of keyboard, the moving keyboard application displays a screen 300 to select a type of keyboard as shown in FIG. 3. As shown in FIG. 3, the type of keyboard may include a Hangul consonant keyboard, a Hangul vowel keyboard, an alphabet small letter keyboard, an alphabet capital letter keyboard, a symbol keyboard, a numeral keyboard, and a third language keyboard. Other types of keyboard may be added or deleted.

For example, when the user touches an add button of the alphabet small letter on the keyboard type selection screen 300 and then touches the enter button, the moving keyboard application generates a keyboard showing alphabet small letters and displays the generated keyboard on the keyboard display 120. Also, when the user touches an add button of the alphabet capital letter on the keyboard type selection screen 300 and then touches the enter button, the moving keyboard application may generate a keyboard showing the alphabet small letters and the alphabet capital letters. Also, when the user touches a remove button of the alphabet small letter and then touches the enter button while the alphabet small letters and the alphabet capital letters moves on the keyboard display 120 like subtitles, the moving keyboard application may generate a keyboard showing only the alphabet capital letters.

Referring back to FIG. 2, when the user selects the arrangements and number of keys on the moving keyboard menu setting screen 200, the moving keyboard application generates a screen to set an arranging method of keys and the number of keys (or characters) to be displayed on the keyboard display 120. The arranging method of the keys includes a single-row method and a multi-row method.

The single-row method is a method in which keys of at least one of a letter keyboard, a numeral keyboard and a symbol keyboard are displayed in a line in single row, and the multi-row method is a method in which keys of at least one of the letter keyboard, the numeral keyboard, and the symbol keyboard are distributed to a plurality of rows or mixed, and displayed. In particular, when the user selects the multi-row method, the moving keyboard application may further generate a screen for a user to select one of a method in which one type of keyboard is displayed in one row or a method in which two or more types of keyboard are mixed.

When the user selects the single-row method, the moving keyboard application may change the arrangements of the moving keyboard displayed on the keyboard display 120 to the single-row arrangements as shown in FIG. 1 according to the user's request.

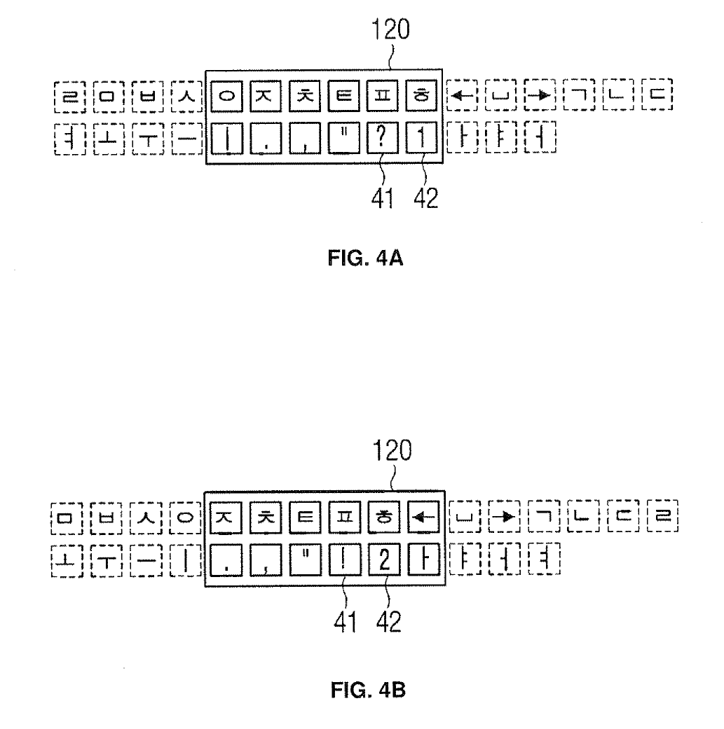

Also, when the user selects the multi-row method, the moving keyboard application may change the arrangements of the moving keyboard displayed on the keyboard display 120 to multi-row arrangements as shown in FIG. 4A. FIG. 4A will be explained below.

Also, when the user sets the number of characters to be displayed on the keyboard display 120 on a row basis, the moving keyboard application may generate a keyboard displaying characters as many as set by the user in a moving method. In the case of FIG. 1, the user sets the number of characters to be displayed on the keyboard display 120 to six.

Referring back to FIG. 2, when the user selects the rotation direction and the rotation speed of the keyboard on the moving keyboard menu setting screen 200, the moving keyboard application generates a screen to set a direction in which the keyboard moves and a speed at which the keyboard moves. The direction in which the keyboard moves may include at least one of a leftward direction (that is, a clockwise direction), a rightward direction (that is, a counter clockwise direction), an upward direction, and a downward direction. Accordingly, the moving keyboard application may generate a screen to select one of up, down, left and right directions as an option for setting a direction in which keyboard moves, and the user may set a moving direction of the keyboard through the generated screen. The setting the direction in which the keyboard moves may be applied to both the landscape view screen and the portrait view screen of the terminal.

Also, the moving keyboard application may generate a screen showing a plurality of stages as an option for setting a keyboard rotation speed. For example, the moving keyboard application may generate a screen which is divided into 5 stages such as ‘very fast’, ‘fast’, ‘moderate’, ‘slow’, and ‘very slow’, and the user may select one of ‘very fast’, ‘fast’, ‘moderate’, ‘slow’, and ‘very slow’. When the user selects a speed that he/she wants, the moving keyboard application may demonstrate a moving speed of the keyboard corresponding to the selected speed in advance. Therefore, the user can identify the speed that he/she has selected in advance before the moving speed is applied to the moving keyboard.

Also, when the user selects the font size of the keyboard on the moving keyboard menu setting screen 200 shown in FIG. 2, the moving keyboard application generates a screen to set a size of a font included in the keyboard. The term ‘font’ includes letters, numerals, and symbols, and, for convenience of explanation, fonts, letters, numerals, and symbols may be interchangeably used. As the size of the font set by the user increases, the moving keyboard application generate a moving keyboard in which the number of characters displayed in one row of the keyboard display 120 is reduced.

When the user selects customization on the moving keyboard menu setting screen 200 shown in FIG. 2, the moving keyboard application generates a screen to add fonts or symbols defined by the user. The user may add fonts or symbols that he/she wants in a file upload method. The moving keyboard application may automatically add the added font to the keyboard type selection screen 300 and may display it.

Also, the moving keyboard application may vary sizes of fonts displayed on the keyboard display 120. When the user selects a menu ‘size of keyboard font’ on the moving keyboard menu setting screen of FIG. 2, the moving keyboard application displays a screen to set sizes of all fonts uniformly or set sizes of fonts differently.

Also, the moving keyboard application may vary sizes or colors of fonts displayed on the keyboard display 120. To achieve this, the moving keyboard menu setting screen of FIG. 2 may further include a menu ‘color of keyboard font’. When the user selects the menu ‘color of keyboard font’, the moving keyboard application displays a color setting screen of a keyboard font to set colors of all fonts uniformly or set colors of fonts differently. For example, the moving keyboard application may display a color setting screen of a keyboard font to set different colors for the letter ‘A’ and the letter ‘B’. For another example, the user may set blue for vowels and set red for consonants.

Also, the moving keyboard application may select borders of fonts displayed on the keyboard display 120. To achieve this, the moving keyboard menu setting screen of FIG. 2 may further include a menu ‘font border setting’. When the user selects the menu ‘font border setting’, the moving keyboard application displays a screen to set a border of a keyboard font. That is, the user may set borders of all fonts uniformly (for example, in a quadrangular, triangular, hexagonal, circular, chain, or star shape), or may set borders of fonts differently.

Also, when the user selects the fixed keyboard on the moving keyboard menu setting screen 200 shown in FIG. 2, the moving keyboard application may generate a fixed QWERTY keyboard which is not movable. When it is difficult to display all keys of the QWERTY keyboard due to a small space, the moving keyboard application may generate some of the keys in a fixed form. For example, only six characters are fixedly displayed on the keyboard display 120 as shown in FIG. 1. In this case, when the user touches and drags the keyboard display 120, the moving keyboard application may generate a keyboard in which characters are moved line by line. Accordingly, when the fixed keyboard is selected, the moving keyboard application may move the keyboard only if the user manually touches and drags the keyboard display 120. This is useful when the user slowly inputs texts or temporarily stops inputting.

The above-described moving keyboard application enables the keyboard to move on a basis of two or more letters.

FIGS. 4A and 4B are views to explain an example of a moving keyboard showing numerals and symbols according to an exemplary embodiment;

Referring to FIGS, 4A and 4B, Hangul vowels and Hangul consonants are arranged on the keyboard display 120 in two rows. The moving keyboard application according to an exemplary embodiment may display one symbol in one pre-designated position 41 and one numeral in another pre-designated position 42. The symbol and numeral displayed in the designated positions 41 and 42 may be changed in sequence, respectively.

For example, when the moving keyboard move to the left key by key with time, the moving keyboard application may generate a moving keyboard in which ‘?” is replaced with “!” in the position 41 and “1” is replaced with “2” in the position 42. As described above, the moving keyboard application may generate a moving keyboard in which the symbol in the position 41 is replaced with another symbol in sequence and the numeral in the position 42 is replaced with another numeral in sequence every time that the keyboard moves.

According to still another exemplary embodiment, the moving keyboard application displays one numeral in one designated position and, when the user touches the numeral in the designated position for a predetermined time, it may generate a pop-up window showing all Arabic numerals. Since all Arabic numerals 0 to 9 are displayed on the pop-up window simultaneously, the user may easily select a numeral that he/she wants on the pop-up window.

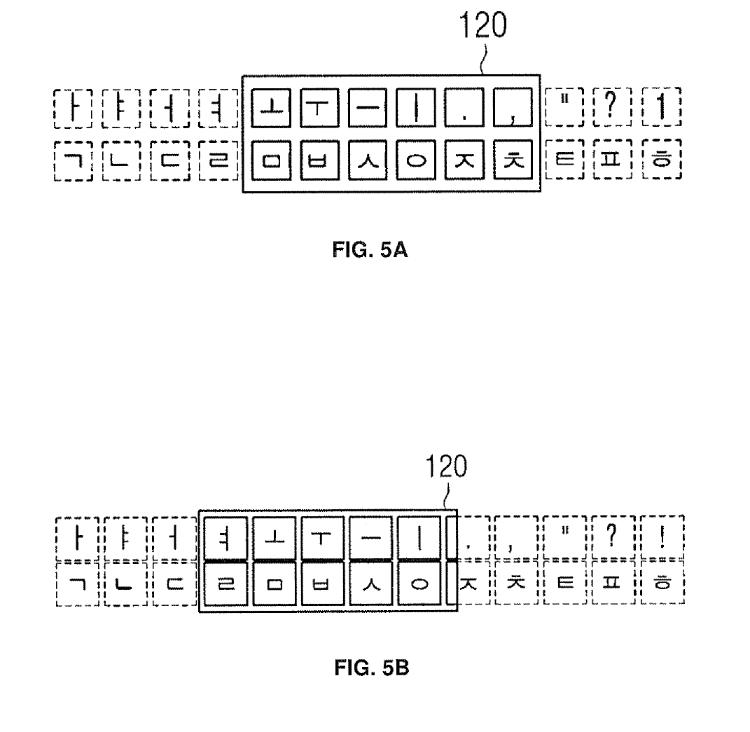

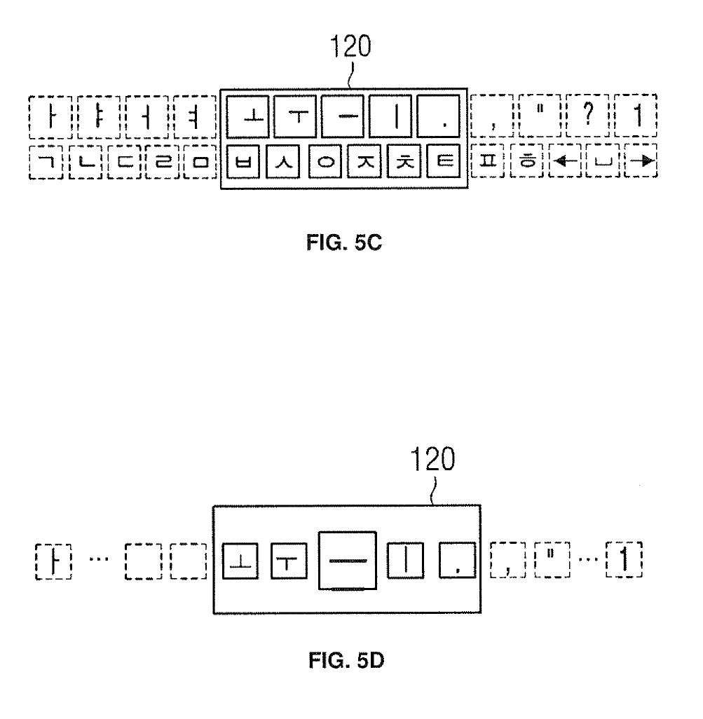

FIG. 5A is a view illustrating an example of a moving Hangul keyboard in which keys are arranged in a multi-row method according to an exemplary embodiment.

Referring to FIG. 5A, when the user selects a multi-row method in which the Hangul consonants and the Hangul vowels are arranged in multi rows, the moving keyboard application may generate a moving Hangul keyboard in which the Hangul consonants and the Hangul vowels are arranged in different rows. Also, the moving keyboard application may display symbol keys and numeral keys in the same row as that of the Hangul vowel keys.

FIG. 5B is a view illustrating an example of a moving Hangul keyboard in which a font size of the keyboard is changed according to an exemplary embodiment.

Referring to FIG. 5B, when the user requests the font size to be larger than the previous one, the moving keyboard application may generate a Hangul keyboard in which the size of the letter displayed on the keyboard display 120 increases. Comparing FIGS. 5A and 5B, the size of the letter displayed on the keyboard display 120 of FIG. 5B is larger than that of FIG. 5A. Therefore, the moving keyboard application generates a moving Hangul keyboard displaying a relatively small number of letters on the keyboard display 120 of FIG. 5B.

Also, the moving keyboard application may vary sizes or colors of fonts displayed on the keyboard display 120. To achieve this, the moving keyboard menu setting screen of FIG. 2 may further include a menu ‘color of keyboard font’. When the user selects the menu ‘color of keyboard font’, the moving keyboard application displays a color setting screen of a keyboard font to set colors of all fonts uniformly or set colors of fonts differently. For example, the moving keyboard application may display a color setting screen of a keyboard font to set different colors for the letter ‘A’ and the letter ‘B’.

Also, the moving keyboard application may vary sizes of fonts displayed on the keyboard display 120. When the user selects a menu ‘size of keyboard font’ on the moving keyboard menu setting screen of FIG. 2, the moving keyboard application displays a screen to set sizes of all fonts uniformly or set sizes of fonts differently.

FIG. 5C is a view illustrating an example of a moving Hangul keyboard in which a font size varies according to a type of keys according to an exemplary embodiment.

Referring to FIG. 5C, when the user sets the Hangul consonants to be relatively smaller than the Hangul vowels through a key font selection screen (not shown), the moving keyboard application may generate a moving Hangul keyboard in which the Hangul vowels and the Hangul consonants are different from each other in their sizes.

FIG. 5D is a view illustrating an example of a moving Hangul keyboard which highlights one of the Hangul letters displayed on the keyboard display according to an exemplary embodiment.

Referring to FIG. 5D, when the user sets a size of a character displayed in a specific position to increase on a screen through which the user is able to set a size of a font of the keyboard, the moving keyboard application may generate a moving keyboard in which a size of a character in the middle position of the keyboard display 120 increases in comparison with other characters. Accordingly, the character displayed in the middle position of the keyboard display 120 has its size increased every time the moving keyboard moves. Therefore, the user can use the moving keyboard more easily.

Although not shown, the moving keyboard application may generate a moving keyboard in which the size of the character gradually increases toward the middle position and gradually decreases away from the middle position of the keyboard display 120.

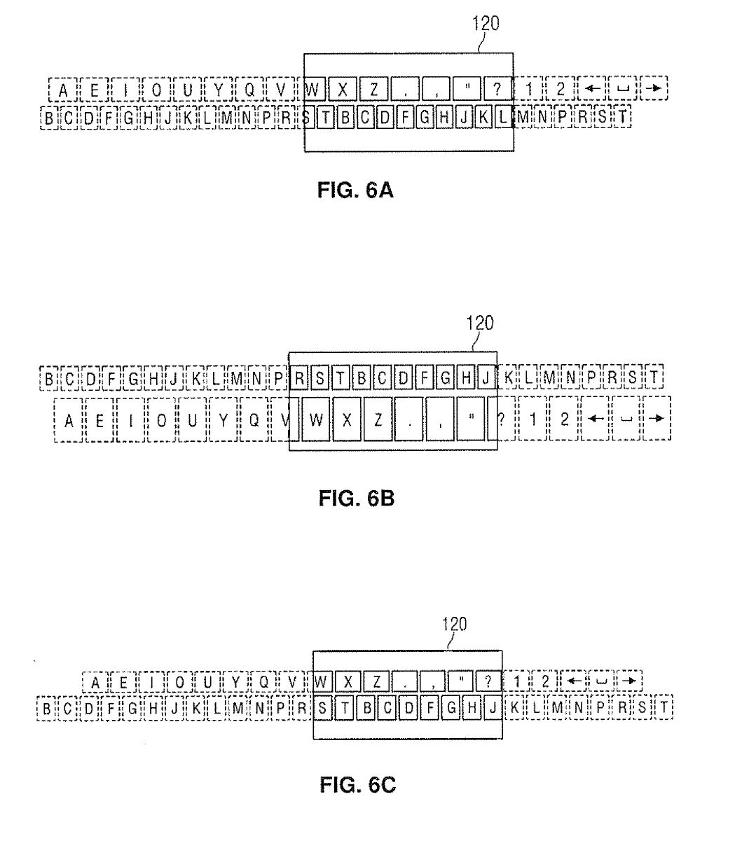

FIG. 6A is a view illustrating an example of a moving alphabet keyboard in which keys are arranged in a multi-row method according to an exemplary embodiment.

Referring to FIG. 6A, the moving keyboard application generates a moving alphabet keyboard in which vowels (A, E, I, O, U) from among the alphabet capital letters and some consonants (Y, Q, V, W, X, Z) are displayed in the same row, and the other alphabet consonants are displayed in the other row, according to a user's request. Also, the moving keyboard application may display numeral keys and symbols keys in the same row as that of the alphabet vowel keys.

FIG. 6B is a view illustrating an example a moving alphabet keyboard in which key arrangements are changed according to an exemplary embodiment.

Referring to FIG. 6B, when the user changes an arranging order of moving alphabet keys which are displayed in a multi-row method, the moving keyboard application may generate a moving alphabet keyboard in which alphabet consonant keys are displayed in the upper row and alphabet vowel keys are displayed on the lower row according to setting of the user. Also, when the user additionally sets the alphabet vowel keys and the alphabet consonant keys to be different from each other in their sizes, the moving keyboard application may generate a moving keyboard in which the characters in the upper row are different from the characters in the lower row in their sizes.

FIG. 6C is a view illustrating an example of a moving alphabet keyboard in which a gap between the different rows of keys is changed according to an exemplary embodiment.

Referring to FIG. 6C, the moving keyboard application generates a moving alphabet keyboard in which a gap between the alphabet vowel keys displayed on the upper row and the alphabet consonant keys displayed on the lower row is enlarged according to a user's request.

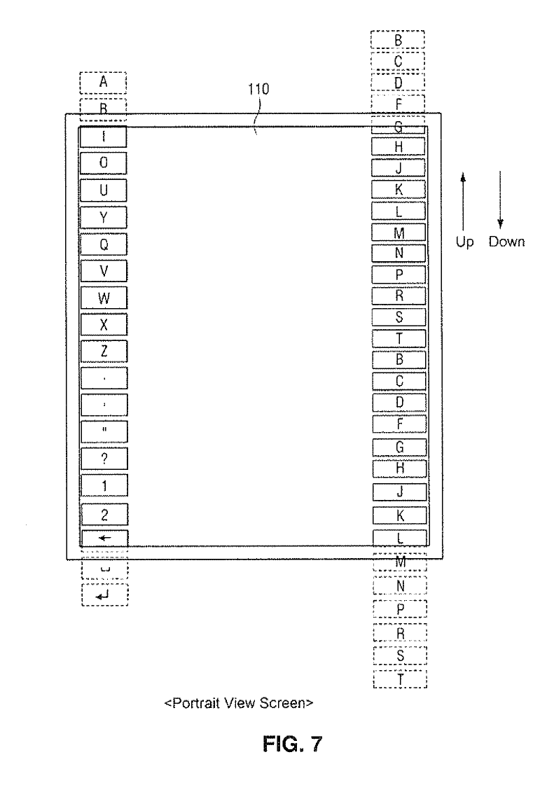

FIG. 7 is a view illustrating an example of a moving keyboard in which keys are displayed on a portrait view screen of a terminal in a vertical direction according to an exemplary embodiment.

Referring to FIG. 7, the moving keyboard application may generate a moving keyboard in which moving keys are displayed in a vertical direction according to a user's request unlike in FIG. 1. In this case, the user may set one of up and down as a moving direction of the moving keyboard. That is, when the user touches a side of the moving keyboard and then drags down, the moving keyboard application may generate a moving keyboard in which the moving keys move down and are changed.

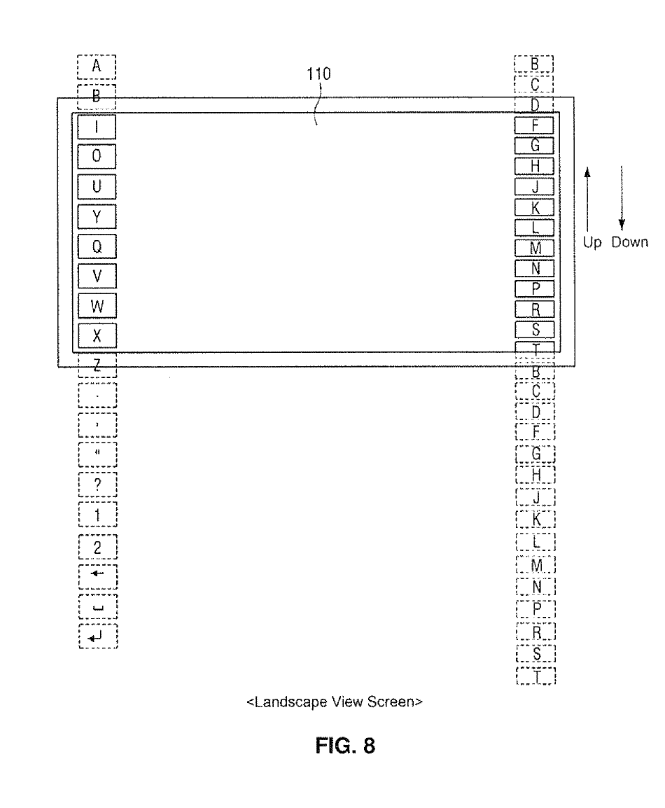

FIG. 8 is a view illustrating an example of a moving keyboard in which moving keys are displayed on a landscape view screen of a terminal in a vertical direction according to an exemplary embodiment.

Referring to FIG. 8, the moving keyboard application may generate a moving keyboard in which keys are displayed in a vertical direction according to a user's request even when the user rotates the display 100 of the terminal in a horizontal direction by 90°.

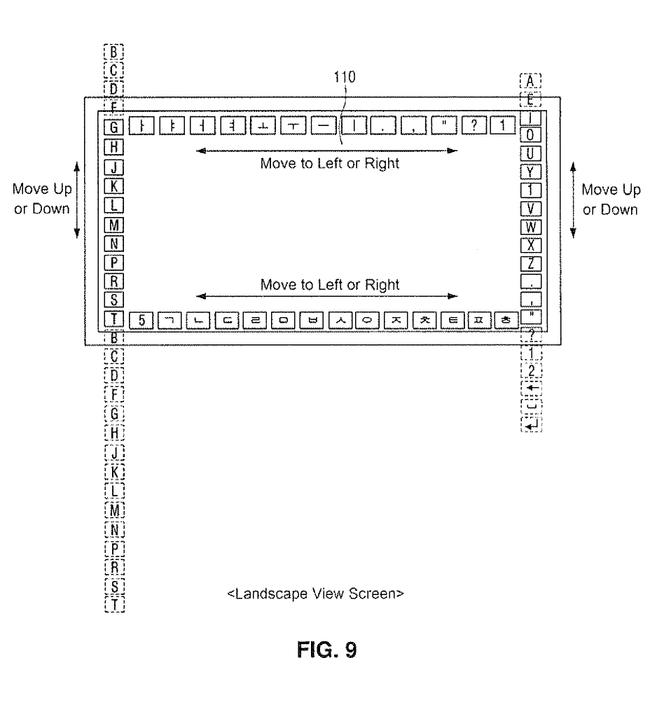

FIG. 9 is a view illustrating an example of a moving keyboard in which keys are displayed on a landscape view screen of a terminal in a horizontal direction and a vertical direction according to an exemplary embodiment.

Referring to FIG. 9, the moving keyboard application may generate a moving keyboard in which moving alphabet keys are displayed in the vertical direction and moving Hangul keys are displayed in the horizontal direction according to a user's request, even when the user rotates the display 100 of the terminal in the horizontal direction by 90°.

Even when the moving keyboard is displayed in the vertical direction as described above, the size of the character of the keyboard may be changed variously as explained above with reference to FIGS. 5A to 6C.

The moving keyboard may move in a diagonal direction, a circular direction, or a certain direction other than the vertical and horizontal directions.

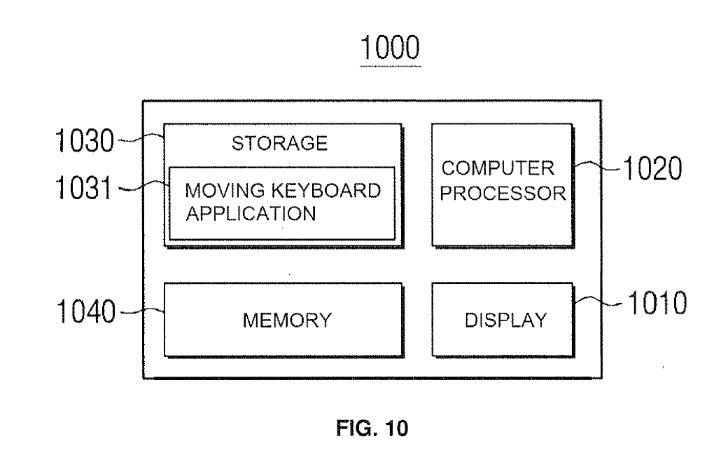

FIG. 10 is a block diagram illustrating a terminal with a moving keyboard according to an exemplary embodiment.

Referring to FIG. 10, a terminal 1000 with a moving keyboard includes a display 1010, a computer processor 1020, a storage 1030, and a memory 1040.

The display 1010 may display a moving keyboard which is generated by a moving keyboard application and a character which is selected through the moving keyboard. The moving keyboard is displayed on a keyboard display of the display 1010 (for example, the keyboard display 120 of FIG. 1), and the selected character is displayed on a data display (for example, the data display 110 of FIG. 1).

The storage 1030 is a non-volatile memory and may store a moving keyboard application 1031. The moving keyboard application 1031 may be the moving keyboard application that has been described above with reference to FIGS. 1 to 10. Hereinafter, exemplary embodiments will be explained briefly using the moving keyboard application 1031. The moving keyboard application 1031 is loaded into the memory 1040 under the control of the computer processor 1020, and may generate a moving keyboard which is displayed while being moved in a pre-set method.

The computer processor 1020 controls to display a moving keyboard generated by the moving keyboard application 1031 on the keyboard display (not shown).

Hereinbelow, the moving keyboard application 1031 will be explained in detail.

First, the moving keyboard application 1031 may generate a moving keyboard which includes a keyboard region (that is, the keyboard display of FIG. 1) to display at least one of a letter, a numeral, and a symbol, and a menu region (for example, the setting part of FIG. 1) to display a menu for setting an environment of the moving keyboard.

If the display 1010 is implemented by using a touch panel, the moving keyboard application 1031 may change a type of moving keyboard displayed on the display 1010 according to a user request input through the touch panel. The type of moving keyboard includes at least one of a Hangul vowel keyboard, a Hangul consonant keyboard, an alphabet small letter keyboard, an alphabet capital letter keyboard, a numeral keyboard, a symbol keyboard, and a third language keyboard.

Also, the moving keyboard application 1031 may display one numeral in one position which is pre-designated from among moving keys, and may change the numeral in the designated position in sequence. This is applied to symbols in the same way.

Also, the moving keyboard application 1031 may display one numeral in one position which is pre-designated from among moving keys, but, when the user touches the numeral in the designated position for a predetermined time, may generate a pop-up window showing all Arabic numerals.

Also, the moving keyboard application 1031 may change a moving direction and a moving speed of the moving keyboard displayed on the display 1010 according to a request of the user input through the touch panel.

Also, the moving keyboard application 1031 may change an arranging method of the moving keyboard displayed on the display 1010 according to a user request input through the touch panel.

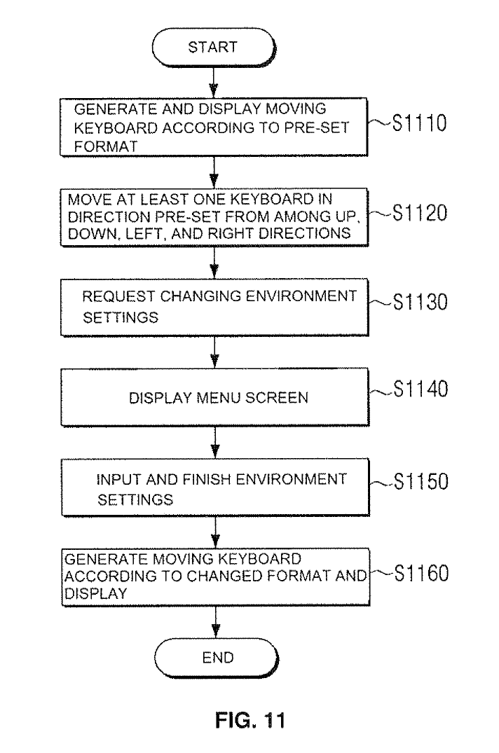

FIG. 11 is a flowchart to explain a method for displaying a moving keyboard of a terminal according to an exemplary embodiment.

The method for displaying the moving keyboard of FIG. 11 may be implemented by one of the terminals described above with reference to FIGS. 1 to 10.

Referring to FIG. 11, the terminal may execute a moving keyboard application and generate a moving keyboard according to a pre-set format, and may display the generated moving keyboard on a screen (S1110).

The terminal may generate a moving keyboard in which keys move in a direction which is set from among up, down, left, and down directions (or a diagonal direction, a circular direction, or a certain direction) at a pre-set speed, and may display the moving keyboard as shown in FIGS. 4A and 4B (S1120)

When the user requests changing environment settings of the moving keyboard by selecting a menu displayed on the terminal (S1130), a menu screen is displayed as shown in FIG. 2 (S1140). In operation S1130, the user may set various environments such as a type of keyboard to be used, arrangements of the keyboard, a moving speed of the keyboard, and a moving direction.

When the user finishes inputting, changing, or adding environment settings of the moving keyboard through the menu screen (S1150), the terminal may generate a moving keyboard according to the format set in operation S1150, and may display the moving keyboard (S1160).

According to an exemplary embodiment, the above-describe method may be implemented by a computer-readable recording medium storing the moving keyboard application according to the exemplary embodiments described above.

While exemplary embodiments have been particularly shown and described above, it will be understood by those of ordinary skill in the art that various changes in form and details may be made therein without departing from the spirit and scope of the present invention as defined by the following claims.

What is claimed is:

1. A terminal with a moving keyboard that comprises a computer processor and a memory, the terminal comprising:
a display; and
a moving keyboard application configured to be loaded into the memory under the control of the computer processor, to generate a moving keyboard which is displayed while moving at a predetermined speed in a pre-set method, and to display the moving keyboard on the display.

2. The terminal with the moving keyboard as claimed in claim 1, wherein the moving keyboard application is configured to generate a menu to set an environment of the moving keyboard and is configured to display the menu on the display.

3. The terminal with the moving keyboard as claimed in claim 1, wherein the display is implemented by a touch panel,
wherein the moving keyboard application is configured to change a type of the moving keyboard displayed on the display according to a user request input through the touch panel,
wherein the type of the moving keyboard comprises at least one of a Hangul vowel keyboard, a Hangul consonant keyboard, an alphabet small letter keyboard, an alphabet capital letter keyboard, a numeral keyboard, a symbol keyboard, and a third language keyboard.

4. The terminal with the moving keyboard as claimed in claim 3, wherein the moving keyboard application is configured to display one numeral in one position which is pre-designated in the moving keyboard, and is configured to change the numeral in the designated position and display the changed numerals as a time elapses.

5. The terminal with the moving keyboard as claimed in claim 3, wherein the moving keyboard application is configured to display one numeral in one position which is pre-designated in the moving keyboard, and, when the user touches the numeral displayed in the designated position for a predetermined time, is configured to generate a pop-up window showing all Arabic numerals.

6. The terminal with the moving keyboard as claimed in claim 1, wherein the display is implemented by a touch panel,
wherein the moving keyboard application is configured to change a moving direction and a moving speed of the moving keyboard displayed on the keyboard display according to a user request input through the touch panel.

7. The terminal with the moving keyboard as claimed in claim 1, wherein the display is implemented by a touch panel,
wherein the moving keyboard application is configured to change an arranging method of the moving keyboard displayed on the keyboard display according to a user request input through the touch panel.

8. The terminal with the moving keyboard as claimed in claim 7, wherein the arranging method of the moving keyboard comprises a single-row method in which keys of at least one of the letter, numeral, and symbol are displayed in one row, and a multi-row method in which keys of at least one of the letter, numeral, and symbol are distributed to a plurality of rows, or mixed, and are displayed.

9. A method for displaying a moving keyboard of a terminal which comprises a computer processor, a memory, and a display, the method comprising:
by a moving keyboard application which is loaded into the memory under the control of the computer processor and operated, generating a moving keyboard which is displayed while moving in a pre-set method; and
displaying the moving keyboard generated by the moving keyboard application on the display.

10. The method as claimed in claim 9, further comprising:
by the moving keyboard application, displaying a menu to change environment settings of the moving keyboard on the display;
receiving a request to change the environment settings of the moving keyboard from a user through a menu displayed on the display; and
when the request to change the environment settings of the moving keyboard is received from the user, by the moving keyboard application, changing the moving keyboard according to the changed environment settings.

11. The method as claimed in claim 10, wherein the environment settings of the moving keyboard comprise a type of the moving keyboard, an arrangement method of the moving keyboard and a number of keys, a moving direction and a moving speed of the moving keyboard, and a font size item of the moving keyboard,
wherein the type of the moving keyboard comprises at least one of a Hangul vowel keyboard, a Hangul consonant keyboard, an alphabet small letter keyboard, an alphabet capital letter keyboard, a numeral keyboard, a symbol keyboard, and a third language keyboard.

12. The method as claimed in claim 11, wherein the arranging method of the moving keyboard comprises a single-row method in which keys of at least one of the letter, numeral, and symbol are displayed in one row, and a multi-row method in which keys of at least one of the letter, numeral, and symbol are distributed to a plurality of rows, or mixed, and are displayed.

13. The method as claimed in claim 9, wherein the generating the moving keyboard comprises generating a transparent keyboard.

14. A non-transitory computer-readable recording medium which stores a program to perform the method for displaying the moving keyboard of the terminal as claimed in claim 9.

15. The non-transitory computer-readable recording medium as claimed in claim 14, wherein the method for displaying the moving keyboard of the terminal further comprises:
by the moving keyboard application, displaying a menu to change environment settings of the moving keyboard on the display;
receiving a request to change the environment settings of the moving keyboard from a user through a menu displayed on the display; and
when the request to change the environment settings of the moving keyboard is received from the user, by the moving keyboard application, changing the moving keyboard according to the changed environment settings.

16. The non-transitory computer-readable recording medium as claimed in claim 15, wherein the environment settings of the moving keyboard comprise a type of the moving keyboard, an arrangement method of the moving keyboard and a number of keys, a moving direction and a moving speed of the moving keyboard, and a font size item of the moving keyboard,
wherein the type of the moving keyboard comprises at least one of a Hangul vowel keyboard, a Hangul consonant keyboard, an alphabet small letter keyboard, an alphabet capital letter keyboard, a numeral keyboard, a symbol keyboard, and a third language keyboard.

17. The non-transitory computer-readable recording medium as claimed in claim 16, wherein the arranging method of the moving keyboard comprises a single-row method in which keys of at least one of the letter, numeral, and symbol are displayed in one row, and a multi-row method in which keys of at least one of the letter, numeral, and symbol are distributed to a plurality of rows, or mixed, and are displayed.

18. The non-transitory computer-readable recording medium as claimed in claim 14, wherein the generating the moving keyboard comprises generating a transparent keyboard.
